(19) United States
(12) Patent Application Publication
(10) Pub. No.: US 2025/0135703 A1
(43) Pub. Date: May 1, 2025

(54) RESIN FILM MANUFACTURING APPARATUS AND ITS CONTROL METHOD

(71) Applicant: THE JAPAN STEEL WORKS, LTD., Tokyo (JP)

(72) Inventors: Soma TANAKA, Tokyo (JP); Tomohiro TATSUGAWA, Tokyo (JP); Shinji SHIBATA, Tokyo (JP); Takafumi NII, Tokyo (JP)

(21) Appl. No.: 18/922,911

(22) Filed: Oct. 22, 2024

(30) Foreign Application Priority Data
Oct. 27, 2023 (JP) 2023-184634

(51) Int. Cl. B29C 48/92; B29C 48/00; B29C 48/08; B29C 48/28; B29C 48/88

(52) U.S. Cl. CPC B29C 48/92; B29C 48/0018; B29C 48/0021; B29C 48/08; B29C 48/28; B29C 48/914; B29C 2948/92076; B29C 2948/92447; B29C 2948/92523; B29C 2948/92933

(57) ABSTRACT

A resin film manufacturing apparatus according to an embodiment includes a film passing sensor for winding, provided on an inlet side of a winding machine and configured to detect passing of a conveyed resin film therethrough. When the manufacturing of the resin film is started, the driving of the winding machine is started after the film passing sensor for winding detects that the resin film has passed therethrough.

### INCORPORATION BY REFERENCE

This application is based upon and claims the benefit of priority from Japanese patent application No. 2023-184634, filed on Oct. 27, 2023, the disclosure of which is incorporated herein in its entirety by reference.

### BACKGROUND

The present disclosure relates to a resin film manufacturing apparatus and its control method.

As disclosed in Patent Literature 1 and 2, the inventors of the present application have developed resin film manufacturing apparatuses and their control methods.
Patent Literature 1: Japanese Unexamined Patent Application Publication No. 2022-092768
Patent Literature 2: Japanese Unexamined Patent Application Publication No. 2023-082321

### SUMMARY

For example, when the winding of a resin film by a winding machine is started at the start of the manufacturing of the resin film, an operator manually fixes the tip of the resin film conveyed from the upstream side to the winding machine, and then manually starts the driving of the winding machine.

Therefore, the inventors of the present application aim to develop a technology for automatically starting the winding of a resin film by a winding machine at the start of the manufacturing of the resin film.

Other problems and novel features will be clarified from the descriptions in this specification and the attached drawings.

A resin film manufacturing apparatus according to an embodiment includes a film passing sensor for winding, provided on an inlet side of a winding machine and configured to detect passing of a conveyed resin film therethrough. When the manufacturing of the resin film is started, the driving of the winding machine is started after the film passing sensor for winding detects that the resin film has passed therethrough.

In a method for controlling a resin film manufacturing apparatus according to an embodiment, when manufacturing of a resin film is started, a computer performs (a) starting driving of a winding machine after a film passing sensor for winding, provided on an inlet side of the winding machine detects that the resin film has passed therethrough.

According to the above-described embodiment, it is possible to provides a resin film manufacturing apparatus capable of automatically starting the winding of a resin film by a winding machine when the manufacturing of the resin film is started.

The above and other objects, features and advantages of the present disclosure will become more fully understood from the detailed description given hereinbelow and the accompanying drawings.

### BRIEF DESCRIPTION OF DRAWINGS

FIG. 1 is a schematic perspective view showing an overall configuration of a resin film manufacturing apparatus according to a first embodiment;

FIG. 2 is a schematic cross-sectional view showing the overall configuration of the resin film manufacturing apparatus according to the first embodiment;

FIG. 3 is a cross-sectional view of a T-die 20;

FIG. 4 is a partial perspective view of a lower side (lip side) of the T-die 20;

FIG. 5 is a flowchart showing an overall procedure of a method for controlling the resin film manufacturing apparatus according to the first embodiment that is performed when the manufacturing of a resin film is started;

FIG. 6 is a schematic cross-sectional view showing the resin film manufacturing apparatus in a control mode MD1 in FIG. 5;

FIG. 7 is a schematic cross-sectional view showing the resin film manufacturing apparatus in a control mode MD2 in FIG. 5;

FIG. 8 is a schematic cross-sectional view showing the resin film manufacturing apparatus in a control mode MD3 in FIG. 5;

FIG. 9 is a schematic cross-sectional view showing the resin film manufacturing apparatus in a control mode MD4 in FIG. 5;

FIG. 10 is a flowchart showing details of the control mode MD1 in FIG. 5;

FIG. 11 is a flowchart showing details of the control mode MD2 in FIG. 5;

FIG. 12 is a schematic cross-sectional view showing a casting machine 30 in a step S21 in FIG. 11;

FIG. 13 is a flowchart showing details of the control mode MD3 in FIG. 5;

FIG. 14 is a schematic cross-sectional view showing the casting machine 30 and a winding machine 40 in a step S31 in FIG. 13;

FIG. 15 is a flowchart showing details of the control mode MD4 in FIG. 5;

FIG. 16 is a flowchart showing details of the control mode MD5 in FIG. 5;

FIG. 17 is a schematic perspective view showing an overall configuration of a resin film manufacturing apparatus according to a second embodiment;

FIG. 18 is a schematic cross-sectional view showing the overall configuration of the resin film manufacturing apparatus according to the second embodiment;

FIG. 19 is a flowchart showing an overall procedure of a method for controlling the resin film manufacturing apparatus according to the second embodiment that is performed when the manufacturing of a resin film is started;

FIG. 20 is a schematic cross-sectional view showing the resin film manufacturing apparatus in a control mode MD6 in FIG. 19;

FIG. 21 is a schematic cross-sectional view showing the resin film manufacturing apparatus in a control mode MD7 in FIG. 19;

FIG. 22 is a schematic cross-sectional view showing the resin film manufacturing apparatus in a control mode MD3 in FIG. 19;

FIG. 23 is a schematic cross-sectional view showing the resin film manufacturing apparatus in a control mode MD4 in FIG. 19;

FIG. 24 is a flowchart showing details of the control mode MD6 in FIG. 19;

FIG. 25 is a schematic cross-sectional view showing a casting machine 30 and a longitudinal stretching machine 60 in a step S61 in FIG. 24;

FIG. 26 is a flowchart showing details of the control mode MD7 in FIG. 19;

FIG. 27 is a schematic cross-sectional view showing the longitudinal stretching machine 60 and a transverse stretching machine 70 in a step S71 in FIG. 26; and

FIG. 28 is a schematic cross-sectional view showing the transverse stretching machine 70 and a winding machine 40 in a step S31 in FIG. 13 in the second embodiment.

### DESCRIPTION OF EMBODIMENTS

Specific embodiments are explained hereinafter in detail with reference to the drawings. However, the present disclosure is not limited to the below-shown embodiments. Further, the following descriptions and the drawings are simplified as appropriate for clarifying the explanation.

### First Embodiment

### <Overall Configuration of Resin Film Manufacturing Apparatus>

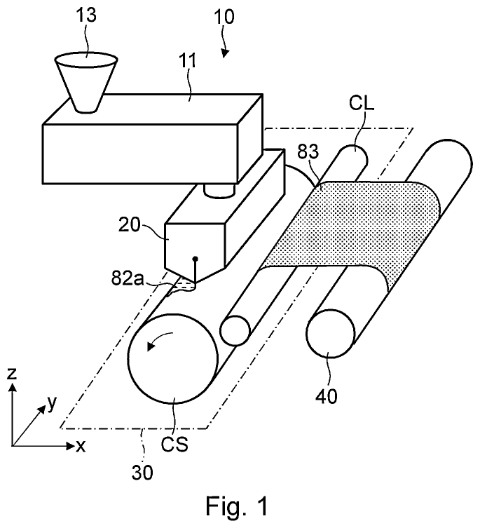

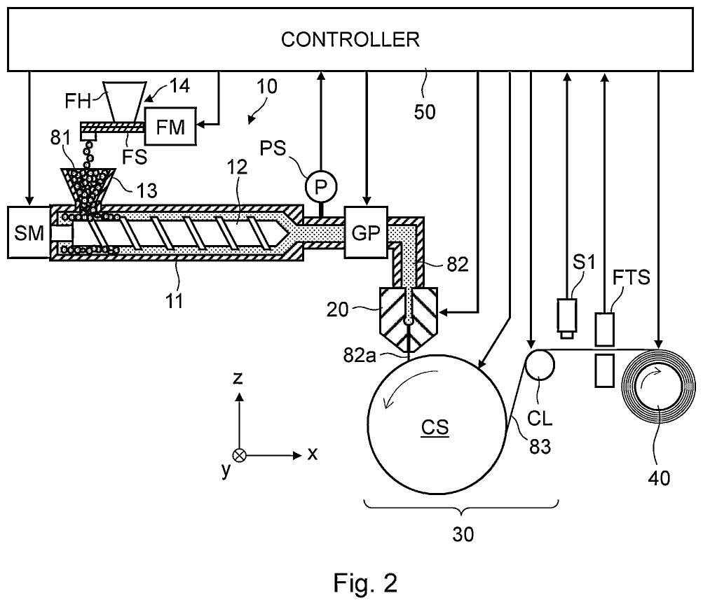

Firstly, an overall configuration of a resin film manufacturing apparatus according to a first embodiment will be described with reference to FIGS. 1 and 2. FIG. 1 is a schematic perspective view showing an overall configuration of a resin film manufacturing apparatus according to the first embodiment. FIG. 2 is a schematic cross-sectional view showing the overall configuration of the resin film manufacturing apparatus according to the first embodiment.

Note that, needless to say, right-handed xyz-orthogonal coordinates shown in FIG. 1 and other drawings are shown for the sake of convenience for explaining the positional relation among components. In general, the z-axis positive direction is the vertically upward direction and the xy-plane is a horizontal plane throughout the drawings.

Further, in this specification, the term “resin film” includes a resin sheet.

As shown in FIGS. 1 and 2, the resin film manufacturing apparatus according to the first embodiment includes an extruder 10, a T-die 20, a casting machine 30, a winding machine 40, and a controller 50. The resin film manufacturing apparatus according to the first embodiment is an extrusion molding-type resin film manufacturing apparatus in which a film-like molten resin 82a is extruded from a gap between lips of the T-die 20 connected to the extruder 10. Note that the controller 50 is omitted in FIG. 1.

The extruder 10 shown in FIGS. 1 and 2 is a screw-type extruder. As shown in FIG. 2, in the extruder 10, a screw 12 extending in the x-axis direction is housed in a cylinder 11 extending in the x-axis direction.

A screw motor SM is connected to the base of the screw 12. The screw motor SM is a driving source for driving the screw 12 and is controlled by the controller 50.

Note that only one screw 12 may be provided, or a plurality of screws 12 may be provided. For example, an extruder 10 with one screw 12 is called a single-screw extruder, while an extruder 10 with two screws 12 is called a twin-screw extruder.

A hopper 13 for charging a resin raw material 81, which is a raw material for a resin film 83, is provided above the end of the cylinder 11 on the negative side in the x-axis direction. The resin raw material 81 is, for example, resin pellets or a resin powder. Further, a raw material feeder 14 for supplying the resin raw material 81 into the cylinder 11 is provided above the hopper 13. The raw material feeder 14 is a screw-type feeder, and includes a feeder hopper FH, a feeder screw FS, and a feeder motor FM.

Note that the method for driving the raw material feeder 14 is not limited in any particular method, and may be a belt-type method or a combination of a screw-type method and a belt-type method.

The resin raw material 81 is charged into the feeder hopper FH and stored therein. When the feeder screw FS is rotationally driven by the feeder motor FM, the resin raw material 81 stored in the feeder hopper FH is supplied into the cylinder 11 through the hopper 13. For example, the controller 50 performs feedback control for the rotation of the feeder motor FM while monitoring the change in mass of the resin raw material 81 stored in the feeder hopper FH. By the above-described configuration, the amount of resin raw material 81 supplied from the raw material feeder 14 to the extruder 10 can be controlled.

Note that a plurality of raw material feeders 14 may be provided.

The resin raw material 81 supplied from the hopper 13 into the cylinder 11 is conveyed from the base of the rotating screw 12 to the tip thereof, i.e., conveyed in the x-axis positive direction. Note that although not shown in the drawing, a heater for heating the inside of the cylinder 11 is provided over the outer peripheral surface of the cylinder 11 over substantially the entire area thereof in the longitudinal direction, so that the resin raw material 81 charged into the cylinder 11 is heated. In this way, the resin raw material 81 is sheared and melted inside the cylinder 11 by the rotating screw 12 while being heated, and is transformed into a molten resin 82.

As shown in FIG. 1, the T-die 20 is connected to the underside of the tip (the end on the positive side in the x-axis direction) of the extruder 10. More specifically, as shown in FIG. 2, the T-die 20 is connected to the lower end of an L-shaped pipe which extends from the tip (the end on the positive side in the x-axis direction) of the extruder in the x-axis positive direction and then extends downward (in the z-axis negative direction). The film-like molten resin 82a is extruded downward (in the z-axis negative direction) from the gap between the lips of the T-die 20 located at the lower end thereof. Note that the distance between the lips (hereinafter also referred to as the lip distance) of the T-die 20 is adjustable. As will be described later in detail, the lip distance of the T-die 20 can be adjusted at a plurality of places along the longitudinal direction of the lips (in the y-axis direction) so that the thickness of the manufactured resin film 83 becomes uniform in the width direction (in the y-axis direction).

Note that as shown in FIG. 2, a gear pump GP is provided in the horizontal part of the pipe, which connects the extruder 10 with the T-die 20. The gear pump GP sucks in (i.e., takes in) the molten resin extruded from the extruder 10 and discharges the sucked-in molten resin to the T-die 20. The gear pump GP is composed of, for example, a pair of gears engaged with each other. One of the gears of the gear pump GP is driven by a motor (not shown).

Note that the pump, which sucks in the molten resin extruded from the extruder 10 and discharges it to the T-die 20, is not limited to the gear pump, and may be any of other types of pumps. Further, a plurality of extruders 10 and/or a plurality of gear pumps GP may be provided for supplying the molten resin 82 to the T-die 20.

As shown in FIG. 1, a pressure sensor PS is provided on the suction side of the gear pump GP in the pipe connecting the extruder 10 with the T-die 20. The pressure sensor PS measures a pressure of the molten resin on the suction side of the gear pump GP. The pressure measured by the pressure sensor PS is input to the controller 50.

As shown in FIGS. 1 and 2, the casting machine 30 includes a cast roll CS and a cooling roll CL.

The cast roll CS discharges a resin film 83, which is formed as the film-like molten resin 82a extruded from the T-die 20 solidifies, to the cooling roll CL while cooling the film-like molten resin 82a.

Then, as shown in FIGS. 1 and 2, the cooling roll CL conveys the resin film 83 while cooling it. The cast roll CS and the cooling roll CL are drive rolls driven by respective driving sources (not shown). The driving sources are, for example, variable-speed motors such as servo motors.

Note that each of the cast roll CS and the cooling roll CL may be equipped with a cooling mechanism for cooling the resin film 83. Further, each of the cast roll CS and the cooling roll CL may be equipped with a heating mechanism for heating the resin film 83.

Further, the casting machine 30 may include a plurality of cast rolls CS and a plurality of cooling rolls CL.

In the resin film manufacturing apparatus according to this embodiment, the resin film 83 discharged from the casting machine 30 is wound up by the winding machine 40. The winding machine 40 is a drive roll driven by a driving source (not shown).

Note that the winding machine 40 may include a plurality of drive rolls driven by a driving source(s). Further, a plurality of winding machines 40 may be provided.

The film thickness sensor FTS is, for example, a noncontact-type thickness sensor and measures the distribution of thicknesses (hereinafter also referred to as the thickness distribution) of the resin film 83, which was discharged from the casting machine 30 and is being conveyed, in the width direction thereof. In the example shown in FIG. 2, the film thickness sensor FTS is disposed so as to vertically sandwich the resin film 83, which is being conveyed in the horizontal direction, between the cooling roll CL and the winding machine 40. Since the film thickness sensor FTS is the noncontact-type sensor, it can be scanned (i.e., moved) in the width direction of the resin film 83 (in the y-axis direction). Therefore, it is possible to measure the thickness distribution of the resin film 83 in the width direction thereof by using a compact film thickness sensor FTS. Further, since the resin film 83 is conveyed in the horizontal direction, the thickness distribution can be accurately measured even when the film thickness sensor FTS is scanned (i.e., moved).

### <Configuration and Operation of Controller 50>

The controller 50 controls the extruder 10, the T-die 20, the casting machine 30, and the winding machine 40. That is, the controller 50 controls the whole resin film manufacturing apparatus according to this embodiment, and thereby controls the manufacturing of the resin film 83. The controller 50 is not limited to any particular controllers, and is called, for example, a PLC (Programmable Logic Controller). The controller 50 may be, for example, a PC (Personal Computer).

Note that although not shown in the drawing, the controller 50 includes, for example, an arithmetic unit such as a CPU (Central Processing Unit) and a memory(ies) such as a RAM (Random Access Memory) and a ROM (Read Only Memory) in which various programs and various data are stored. That is, the controller 50 functions as a computer, and controls the extruder 10, the T-die 20, the casting machine 30, and the winding machine 40 based on the aforementioned various programs.

Therefore, the controller 50 shown in FIG. 2 can be formed, when being formed as hardware, by the aforementioned CPU, the memory(ies), and other circuits. Alternatively, the controller 50 can be implemented, when being implemented as software, by programs and the like stored in a memory. That is, the controller 50 can be implemented in various forms by hardware, software, or a combination thereof.

Regarding the control of the extruder 10, the controller 50 controls the extruder 10 so that the pressure of the molten resin 82 on the suction side of the gear pump GP measured by the pressure sensor PS is maintained at a target pressure. Specifically, the controller 50 performs feedback control for the amount of resin raw material 81 supplied from the raw material feeder 14 and the rotation speeds of the screw 12 and the gear pump GP based on the pressure of the molten resin 82 measured by the pressure sensor PS.

That is, as shown in FIG. 2, the controller 50 performs feedback control for the feeder motor FM, the screw motor SM, and the gear pump GP based on the pressure of the molten resin 82 measured by the pressure sensor PS. It is possible to, by maintaining the pressure of the molten resin 82 on the suction side of the gear pump GP at the target pressure, maintain the amount of molten resin 82 flowing into the T-die 20 at a constant amount.

Note that when the manufacturing of a resin film 83 is started, the controller 50 performs feedback control for the rotation speed of the gear pump GP so as to maintain the pressure of the molten resin 82 on the suction side of the gear pump GP at the target pressure.

When the rotation speed of the gear pump GP is increased, the amount of molten resin 82 sucked in by the gear pump GP increases, so that the pressure of the molten resin 82 on the suction side of the gear pump GP decreases. Conversely, when the rotation speed of the gear pump GP is decreased, the amount of molten resin 82 sucked in by the gear pump GP decreases, so that the pressure of the molten resin 82 on the suction side of the gear pump GP rises.

Therefore, when the controller 50 performs feedback control for the rotation speed of the gear pump GP, if the pressure measured by the pressure sensor PS is lower than the target pressure, the rotation speed of the gear pump GP is decreased. Conversely, if the measured pressure is higher than the target pressure, the rotation speed of the gear pump GP is increased.

Meanwhile, when the resin film 83 is manufactured as a product, the controller 50 performs feedback control for the amount of resin raw material 81 supplied from the raw material feeder 14 and the rotation speed of the screw 12 so as to maintain the pressure of the molten resin 82 on the suction side of the gear pump GP at the target pressure. That is, when a product is manufactured, the rotation speed of the gear pump GP is fixed.

When the rotation speed of the screw 12 is increased, the amount of molten resin 82 extruded (i.e., pushed) toward the gear pump GP increases, so that the pressure of the molten resin 82 on the suction side of the gear pump GP rises. Conversely, when the rotation speed of the screw 12 is reduced, the amount of molten resin 82 extruded (i.e., pushed) toward the gear pump GP decreases, so that the pressure of the molten resin 82 on the suction side of the gear pump GP decreases.

Therefore, when the controller 50 performs feedback control for the rotation speed of the screw 12, if the pressure measured by the pressure sensor PS is lower than the target pressure, the rotation speed of the screw 12 is increased. In this case, the amount of resin raw material 81 supplied from the raw material feeder 14 is also increased at the same time. Conversely, if the measured pressure is higher than the target pressure, the rotation speed of the screw 12 is decreased. In this case, the amount of resin raw material 81 supplied from the raw material feeder 14 is also decreased at the same time.

Further, as shown in FIG. 2, for the control of the T-die 20, the controller 50 performs feedback control for the lip distance of the T-die 20 based on the thickness distribution of the resin film 83 acquired from the film thickness sensor FTS. More specifically, the controller 50 controls the lip distance of the T-die 20 so that the thickness of the resin film 83 becomes uniform in the width direction thereof.

Further, as shown in FIG. 2, for the control of the casting machine 30 and the winding machine 40, the controller 50 controls the rotation speeds of the cast roll CS, the cooling roll CL, and the driving source (e.g., a motor (not shown)) for driving the winding machine 40. For example, the controller 50 controls the rotation speed of the driving source for driving the winding machine 40 so as to maintain the tension of the resin film 83 in the winding machine 40 at a constant tension.

Further, when the manufacturing of a resin film 83 is started, the controller 50 starts driving the winding machine 40 at a predetermined timing after detecting, by a film passing sensor S1 shown in FIG. 2, that the resin film 83 has passed therethrough. That is, the winding of the resin film 83 by the winding machine 40 is started.

Note that the film passing sensor S1 is a film passing sensor for winding that is provided on the inlet side of the winding machine 40 and detects, when the manufacturing is started, the passing of the conveyed resin film 83 therethrough. Meanwhile, in this embodiment, it can also be said that the film passing sensor S1 is provided on the outlet side of the casting machine 30 and can detect, when the manufacturing is started, that the resin film 83 has passed through the casting machine 30. The film passing sensor S1 is not limited to any particular sensors as long as it can detect the passing of the resin film 83 therethrough. For example, the film passing sensor S1 is a photoelectric sensor or a temperature sensor.

Note that although the film thickness sensor FTS is disposed between the film passing sensor S1 and the winding machine 40 in FIG. 2, the film passing sensor S1 may be disposed between the film thickness sensor FTS and the winding machine 40.

Alternatively, a film passing sensor may be provided on each of the outlet side of the casting machine 30 and the inlet side of the winding machine 40.

As described above, the resin film manufacturing apparatus according to this embodiment includes the film passing sensor S1, which is provided on the inlet side of the winding machine 40 and detects the passing of the conveyed resin film 83 therethrough. Further, when the manufacturing of a resin film 83 is started, the driving of the winding machine 40 is started after it is detected, by the film passing sensor S1, that the resin film 83 has passed therethrough. Therefore, in the resin film manufacturing apparatus according to this embodiment, it is possible to, when the manufacturing of the resin film is started, automatically start the winding of the resin film by the winding machine.

### <Structure of T-Die 20>

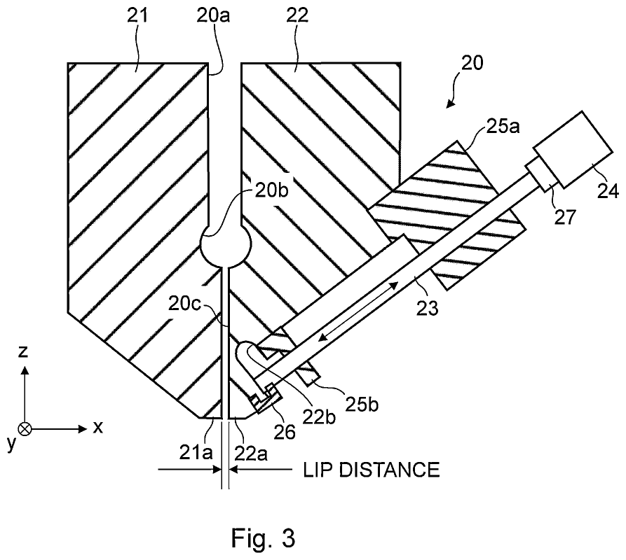

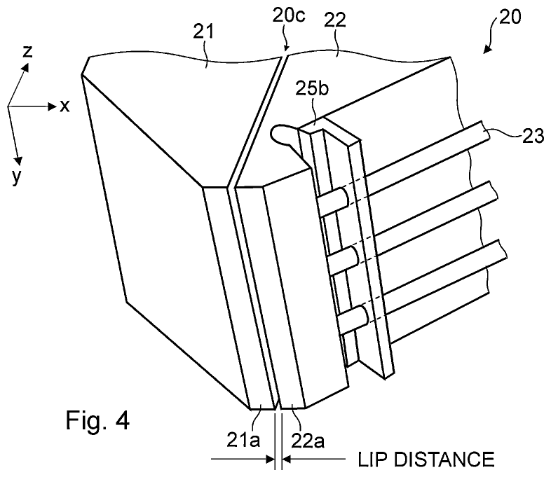

The structure of the T-die 20 will be described hereinafter in a more detailed manner with reference to FIGS. 3 and 4. FIG. 3 is a cross-sectional view of the T-die 20. Further, FIG. 4 is a partial perspective view of the lower side (the lip side) of the T-die 20.

As shown in FIGS. 3 and 4, the T-die 20 is composed of a pair of die blocks 21 and 22 that are arranged so as to abut against each other. In each of the pair of die blocks 21 and 22, which are arranged so as to abut against each other, a tapered part that is inclined downward from the outer-side surface toward the inner-side surface (the abutting surface) is formed. That is, thin lips 21a and 22a are provided at the lower ends of the abutting surfaces of the die blocks 21 and 22, respectively.

In the abutting surfaces of the pair of die blocks 21 and 22, an inlet port 20a, a manifold 20b, and a slit 20c are formed. The inlet port 20a extends downward (in the z-axis negative direction) from the upper surface of the T-die 20. The manifold 20b extends from the lower end of the inlet port 20a in the y-axis positive direction and the y-axis negative direction. In this way, the inlet port 20a and the manifold 20b are formed in a T-shape in the T-die 20.

Further, the slit 20c extending from the bottom surface of the manifold 20b to the lower surface of the T-die 20 extends in the y-axis direction. The molten resin 82 is extruded downward from the slit 20c (i.e., from the gap between the lips 21a and 22a) through the inlet port 20a and the manifold 20b.

Note that while the lip 21a is a fixed stationary lip, the lip 22a is a movable lip connected to adjustment bolts 23. In the lip 22a, a cut-out groove 22b is formed so as to extend obliquely upward from the outer-side surface toward the abutting surface. The lip 22a is pushed and pulled by the adjustment bolts 23, so that the lip 22a can be moved by using the bottom of the cut-out groove 22b as a fulcrum. As described above, only the lip 22a is formed as a movable lip, so that the lip distance can be easily adjusted by a simple structure.

As shown in FIGS. 3 and 4, the adjustment bolt 23 extends in an obliquely upward direction along the tapered part of the die block 22. The adjustment bolts 23 are supported by holders 25a and 25b fixed to the die block 22. More specifically, the adjustment bolts 23 are screwed into threaded holes formed in the holder 25a. In contrast, although the adjustment bolts 23 are inserted through through-holes formed in the holder 25b, they are not screwed into the holder 25b.

Note that the holders 25a and 25b do not necessarily have to be formed as components that are provided separately from the die block 22. That is, they may be integrally formed with the die block 22. Further, the adjustment bolts 23 may be screwed into the holder 25b.

Note that as shown in FIG. 4, a plurality of adjustment bolts 23 are arranged along the longitudinal direction of the lips 21a and 22a (in the y-axis direction). The longitudinal direction of the lips 21a and 22a corresponds to (i.e., substantially parallel to) the width direction of the resin film. Although only three adjustment bolts 23 are provided in the example shown in FIG. 4 for simplifying the drawing, the number of adjustment bolts 23 provided in the die block is usually larger than three.

A motor 24 is provided for each adjustment bolt 23 to adjust the tightening amount (tightening strength) of the adjustment bolt 23. In the example shown in FIGS. 3 and 4, for each adjustment bolt 23, a motor 24 is connected to the upper end of that adjustment bolt 23 through a connecting member 27. It is possible, by tightening (i.e., screwing) the adjustment bolts 23 by the motor 24, to push the lip 22a by the lower end surfaces of the adjustment bolts 23. Further, the lower ends of the adjustment bolts 23 are connected to the lip 22a by a connecting member 26 which has a U-shape in cross section and is fixed to the lip 22a. Therefore, by loosening (i.e., unscrewing) the adjustment bolts 23 by the motor 24, the lip 22a can be pulled through the connecting member 26.

It is possible to adjust the distance between the lips 21a and 22a by adjusting the tightness of the adjustment bolts 23. Specifically, when the tightness of the adjustment bolts 23 are increased, the adjustment bolts 23 push the lip 22a, so that the distance between the lips 21a and 22a is reduced. On the other hand, when the tightness of the adjustment bolt 23 are reduced, the distance between the lips 21a and 22a is increased. The tightening amount (or tightening strength) of each adjustment bolt 23, i.e., the rotation amount of each motor 24, is also controlled by the controller 50.

Note that a technique in which each adjustment bolt 23 is heated by a heater provided in that adjustment bolt 23, and the lip gap is finely adjusted by the amount of thermal expansion thereof is known. Specifically, when the heating temperature of the adjustment bolt 23 is raised, the amount of thermal expansion thereof increases, so that the adjustment bolt 23 pushes the lip 22a and the lip gap is thereby reduced. Conversely, when the heating temperature of the adjustment bolt 23 is lowered, the amount of thermal expansion thereof decreases, so that the lip gap is increased. In the case of such a technique, the heating by each heater is also controlled by the controller 50.

### <Overall Procedure of Method for Controlling Resin Film Manufacturing Apparatus>

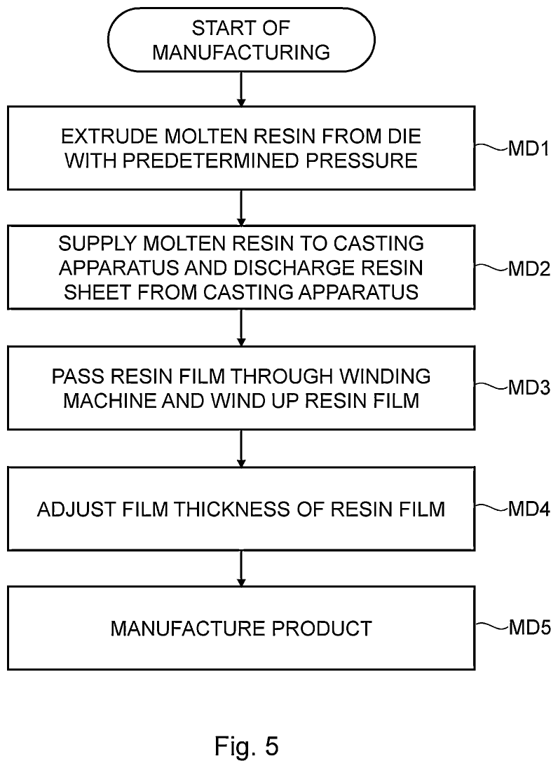

Next, an overall procedure of a method for controlling a resin film manufacturing apparatus according to the first embodiment that is performed when the manufacturing of a resin film is started will be described with reference to FIG. 2 and FIGS. 5 to 9. FIG. 5 is a flowchart showing an overall procedure of a method for controlling a resin film manufacturing apparatus according to the first embodiment that is performed when the manufacturing of a resin film is started.

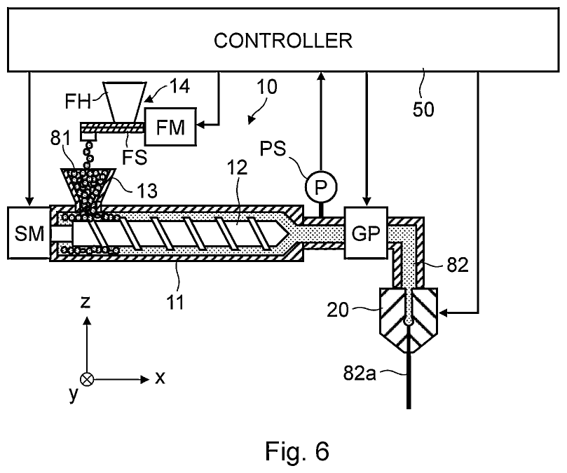

FIGS. 6 to 9 are schematic cross-sectional views showing the resin film manufacturing apparatus in control modes MD1 to MD4, respectively, in FIG. 5. FIG. 2 shows the resin film manufacturing apparatus in the control mode MD5 in FIG. 5.

Note that the control of the resin film manufacturing apparatus shown in FIG. 5 is performed by the controller 50, which is a computer. Details of each of the control modes MD1 to MD5 shown in FIG. 5 will be described later.

Firstly, as shown in FIGS. 5 and 6, the driving of the extruder 10 is started, and a film-like molten resin 82a is extruded from the T-die 20 with a predetermined pressure (Control Mode MD1).

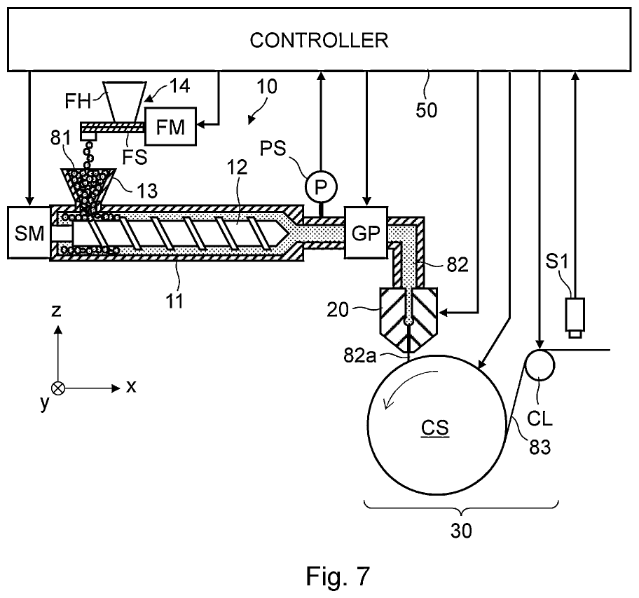

Next, as shown in FIGS. 5 and 7, the driving of the casting machine 30 is started, and while the film-like molten resin 82a is being supplied to the cast roll CS, a resin film 83 is discharged from the cooling roll CL (Control Mode MD2).

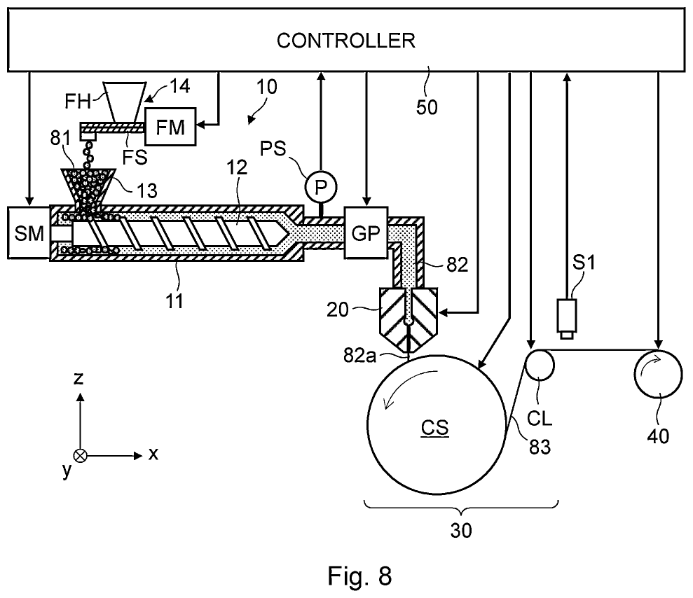

Next, as shown in FIGS. 5 and 8, the driving of the winding machine 40 is started, and the resin film 83 is passed through and wound up around the winding machine 40 (Control Mode MD3). Specifically, the controller 50 starts driving the winding machine 40 at a predetermined timing after detecting, by the film passing sensor S1 shown in FIG. 8, that the resin film 83 has passed therethrough.

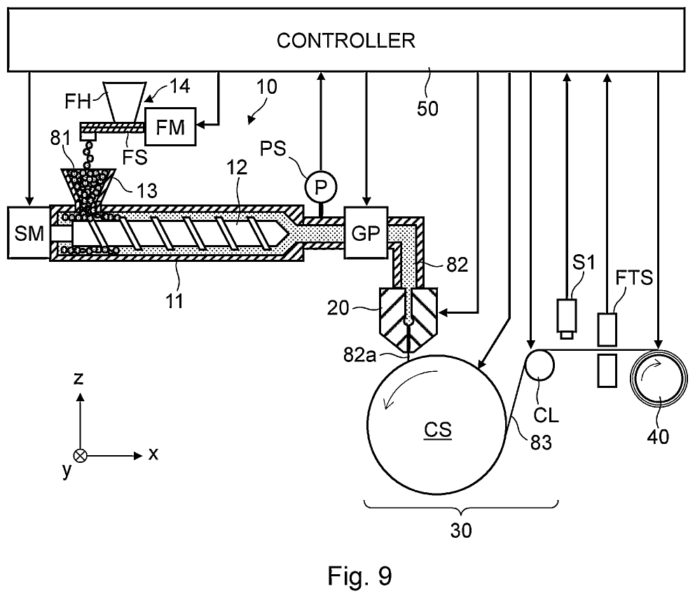

Next, as shown in FIGS. 5 and 9, the film thickness of the resin film 83 is adjusted (Control Mode MD4). Specifically, the controller 50 performs feedback control for the lip distance of the T-die 20 based on the thickness distribution of the resin film 83 acquired from the film thickness sensor FTS shown in FIG. 9.

Then, as shown in FIGS. 2 and 5, after the control mode MD4 for adjusting the film thickness of the resin film 83 is finished, the controller 50 switches the control mode to the control mode MD5 for manufacturing a product. That is, the manufacturing of the resin film 83 as a product is started.

### <Details of Control Mode MD1>

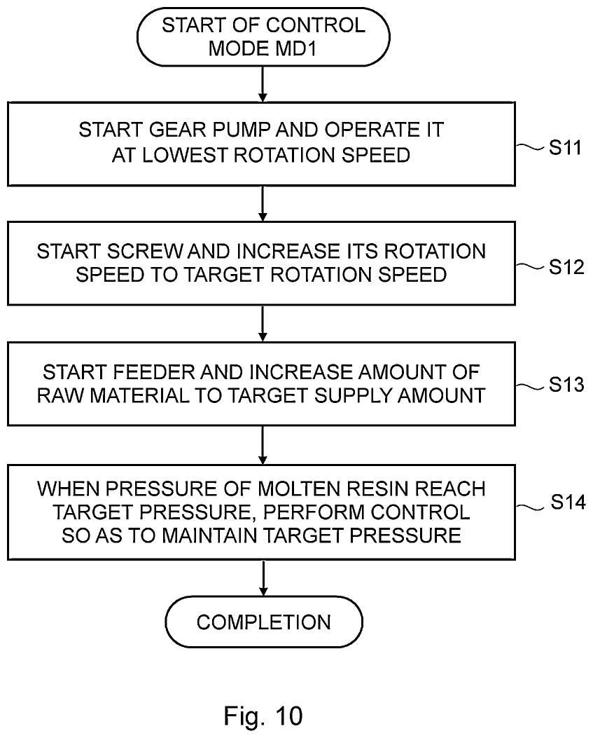

Next, details of the control mode MD1 in FIG. 5 will be described with reference to FIGS. 6 and 10. FIG. 10 is a flowchart showing details of the control mode MD1 in FIG. 5.

Note that the control shown in FIG. 10 is performed by the controller 50, which is a computer. Note that “Start of Control Mode MD1” in FIG. 10 corresponds to the “Start of Manufacturing” in FIG. 5. For example, the control mode MD1 is started by an operation of the controller 50 by an operator, and the controller 50 performs the subsequent control.

Firstly, as shown in FIG. 10, the gear pump GP shown in FIG. 6 is started and operated at the lowest rotation speed (Step S11).

Next, as shown in FIG. 10, the screw 12 shown in FIG. 6, i.e., the screw motor SM, is started, and its rotation speed is increased to a target rotation speed (Step S12).

Next, as shown in FIG. 10, the raw material feeder 14 shown in FIG. 6, i.e., the feeder motor FM, is started, and the amount of resin raw material 81, which is the raw material, supplied to the cylinder 11 is increased to a target supply amount (Step S13).

Then, when the pressure of the molten resin 82 reaches a target pressure, control is performed so as to maintain the target pressure (Step S14). Specifically, the controller 50 performs feedback control for the rotation speed of the gear pump GP so as to maintain the pressure of the molten resin 82 on the suction side of the gear pump GP, measured by the pressure sensor PS shown in FIG. 6 at a predetermined target pressure.

Thorough the above-described series of processes, the control mode MD1 is completed. Note that needless to say, there may be a lapse (e.g., a wait) of a predetermined time by a timer or the like between each of the steps and a step next to that step. The same applies in the following description.

Note that the steps S12 to S14 may be repeated while increasing each of (or at least one of) the target rotation speed of the screw in the step S12, the target amount of raw material to be supplied in the step S13, and the target pressure in the step S14 in a stepwise manner.

### <Details of Control Mode MD2>

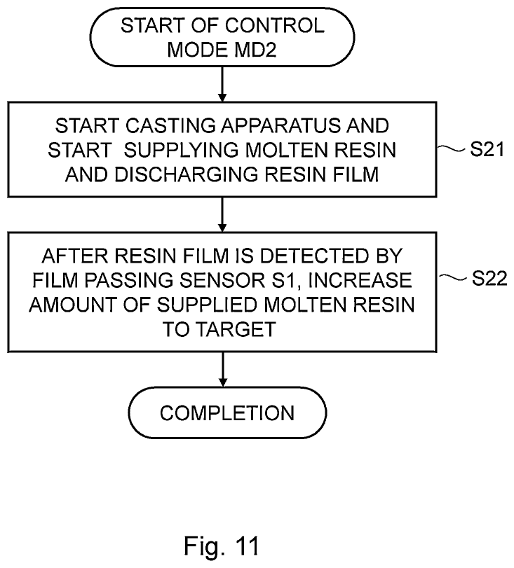

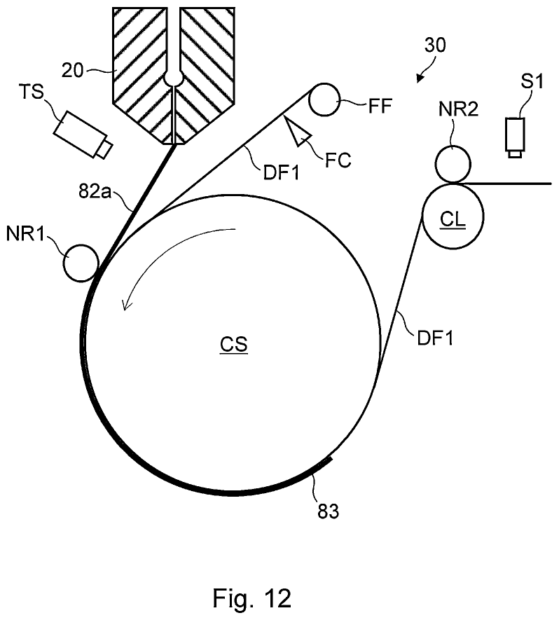

Next, details of the control mode MD2 in FIG. 5 will be described with reference to FIGS. 11 and 12. FIG. 11 is a flowchart showing details of the control mode MD2 in FIG. 5. FIG. 12 is a schematic cross-sectional view showing the casting machine 30 in a step S21 in FIG. 11.

Note that the control shown in FIG. 11 is also performed by the controller 50, which is a computer.

Firstly, as shown in FIG. 11, the casting machine 30 is started, and a film-like molten resin 82a is supplied to the cast roll CS, so that the discharge of a resin film 83 from the cooling roll CL is started (Step S21).

An example of the step S21 will be described hereinafter with reference to FIG. 12. In the example shown in FIG. 12, the casting machine 30 includes, in addition to the cast roll CS and the cooling roll CL shown in FIG. 2, a dummy film feeder FF, a dummy film cutter FC, nip rolls NR1 and NR2, and a temperature sensor TS.

In the example shown in FIG. 12, a dummy film DF1 for casting is passed through the cast roll CS and the cooling roll CL in advance before the casting machine 30 is started. Specifically, a dummy film DF1 supplied from the dummy film feeder FF is passed through the cast roll CS and the cooling roll CL, and the leading end of the dummy film DF1 is sandwiched between the cooling roll CL and the nip roll NR2. These operations are, for example, manually performed, but may be performed by a robot or the like.

Then, when the temperature sensor TS detects a film-like molten resin 82a, the driving of the casting machine 30, i.e., the cast roll CS and the cooling roll CL, is started, and they are rotated at a low speed. When doing so, the film-like molten resin 82a is pressed against and stuck over the dummy film DF1 over the cast roll CS by the nip roll NR1. The dummy film DF1 is fed out of the dummy film feeder FF according to the rotations of the cast roll CS and the cooling roll CL.

Note that the driving of the cast roll CS and the cooling roll CL may be started at a predetermined timing after the control mode MD2 is started (i.e., after the completion of the control mode MD1) without detecting the film-like molten resin 82a by the temperature sensor TS. That is, the temperature sensor TS is not indispensable.

After that, when a resin film 83 discharged from the cooling roll CL is detected by the film passing sensor S1 shown in FIG. 12, the dummy film DF1 is cut by the dummy film cutter FC. Note that, for example, the width of the dummy film DF1 is different from the width of the resin film 83, and a plurality of film passing sensors S1 are arranged in the depth direction in the drawing shown in FIG. 12. Therefore, the resin film 83 can be detected by the film passing sensor S1 (i.e., the plurality of film passing sensors S1) while being distinguished from the dummy film DF1.

Then, as shown in FIG. 11, the amount of supplied molten resin 82 is increased to a target value (Step S22). Thorough the above-described series of processes, the control mode MD2 is completed.

### <Details of Control Mode MD3>

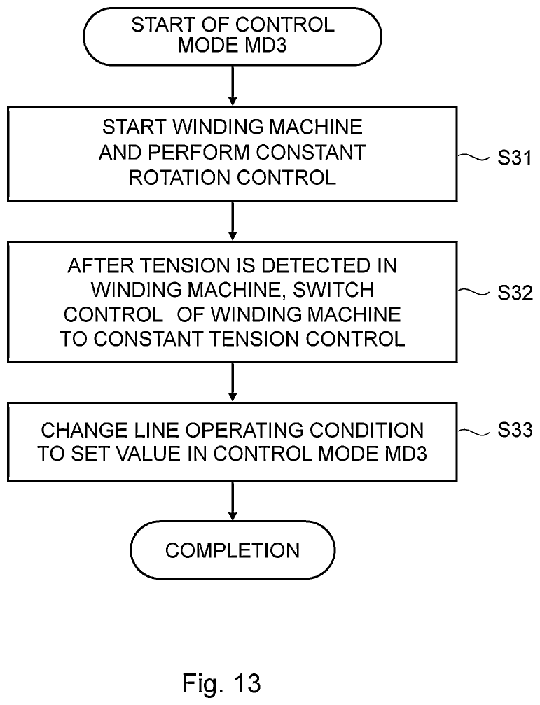

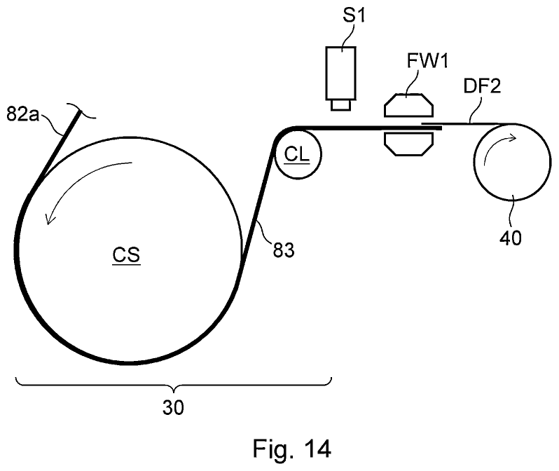

Next, details of the control mode MD3 in FIG. 5 will be described with reference to FIGS. 13 and 14. FIG. 13 is a flowchart showing details of the control mode MD3 in FIG. 5. FIG. 14 is a schematic cross-sectional view showing the casting machine 30 and the winding machine 40 in a step S31 in FIG. 13.

Note that the control shown in FIG. 13 is also performed by the controller 50, which is a computer.

Firstly, as shown in FIG. 13, the winding machine 40 is started, and the winding of the resin film 83 is started under constant rotation control (Step S31). Specifically, the resin film 83 is detected by the film passing sensor S1, and the winding machine 40 is started at a predetermined timing after the step S22 in FIG. 11.

An example of the step S31 will be described hereinafter with reference to FIG. 14. In the example shown in FIG. 14, a film connecting apparatus FW1 for winding that connects films to each other is provided between the film passing sensor S1 and the winding machine 40. For example, the film connecting apparatus FW1 welds resin films to each other.

Before starting the winding machine 40 in the step S31, the leading end of a dummy film DF2 for winding is fixed to the winding machine 40 in advance. Meanwhile, the trailing end of the dummy film DF2 is disposed in the film connecting apparatus FW1 in advance. These operations are, for example, manually performed, but may be performed by a robot or the like.

Then, after a resin film 83 discharged from the casting machine 30 is detected by the film passing sensor S1, the resin film 83 and the dummy film DF2 are connected to each other by the film connecting apparatus FW1 at a predetermined timing, and then, the winding machine 40 is started. Through this series of operations, it is possible to automatically pass the resin film 83 through the winding machine 40, and thereby to automatically start the winding of the resin film 83.

Next, as shown in FIG. 13, after a tension by the resin film 83 is detected in the winding machine 40, the control of the winding machine 40 is switched from the constant rotation control to constant tension control (Step S32).

Then, as shown in FIG. 13, a line operating condition is changed to a set value for the control mode MD3 (Step S33). For example, a line speed is increased to a set value for the control mode MD3. Thorough the above-described series of processes, the control mode MD3 is completed.

### <Details of Control Mode MD4>

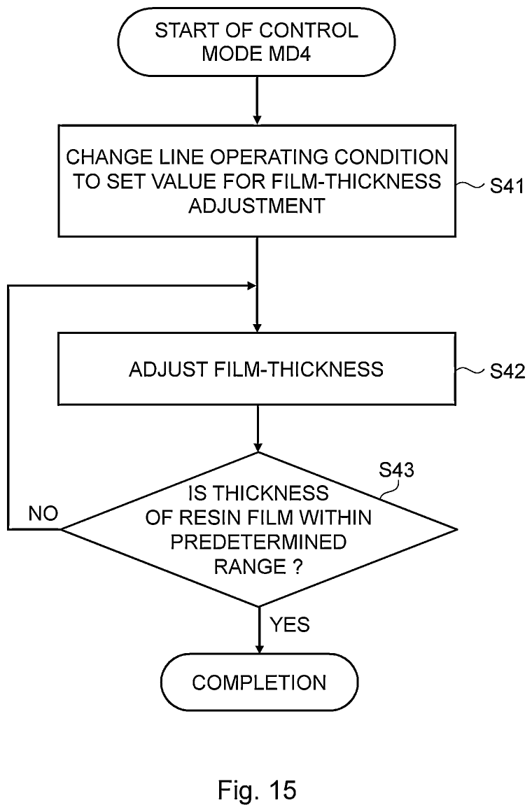

Next, details of the control mode MD4 in FIG. 5 will be described with reference to FIG. 15. FIG. 15 is a flowchart showing details of the control mode MD4 in FIG. 5.

Note that the control shown in FIG. 15 is also performed by the controller 50, which is a computer.

Firstly, as shown in FIG. 15, the line operating condition is changed to a set value for film thickness adjustment (Step S41). For example, the line speed is increased to a set value for film thickness adjustment.

Next, as shown in FIG. 15, the film thickness is adjusted (Step S42). Specifically, the controller 50 performs feedback control for the lip distance of the T-die 20 based on the thickness distribution of the resin film 83 acquired from the film thickness sensor FTS shown in FIG. 9.

Then, as shown in FIG. 15, when the thickness of the resin film 83 is not within a predetermined range (No at Step S43), the adjustment of the film thickness in the step S42 is continued. On the other hand, when the thickness of the resin film 83 is within the predetermined range (Yes at Step S43), the control mode MD4, i.e., the film thickness adjustment, is completed.

Note that the steps S41 to S43 may be repeated while increasing the line speed to a set value for film thickness adjustment in a stepwise manner.

### <Details of Control Mode MD5>

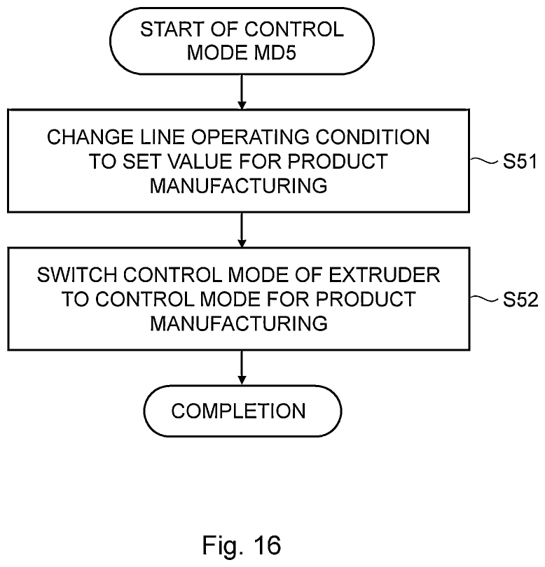

Next, details of the control mode MD5 in FIG. 5 will be described with reference to FIG. 16. FIG. 16 is a flowchart showing details of the control mode MD5 in FIG. 5.

Note that the control shown in FIG. 16 is also performed by the controller 50, which is a computer.

Firstly, as shown in FIG. 16, the line operating condition is changed to a set value for product manufacturing (Step S51). For example, the line speed is increased to a set value for product manufacturing.

Next, as shown in FIG. 16, the control mode of the extruder 10 is switched from the control mode that has been used since the manufacturing was started to a control mode for product manufacturing (Step S52). Thorough the above-described series of processes, the control mode MD5 is completed.

As described above, in the control mode of the extruder 10 at the start of the manufacturing, feedback control is performed for the rotation speed of the gear pump GP so as to maintain the pressure of the molten resin 82 on the suction side of the gear pump GP at the target pressure. Meanwhile, in the control mode of the extruder 10 during the product manufacturing, feedback control is performed for the amount of resin raw material 81 supplied from the raw material feeder 14 and the rotation speed of the screw 12 so as to maintain the pressure of the molten resin 82 on the suction side of the gear pump GP at the target pressure. During these processes, the rotation speed of the gear pump GP is fixed.

Note that in FIG. 16, the completion of the control mode MD5 means the continuation of the product manufacturing.

### Second Embodiment

### <Overall Configuration of Resin Film Manufacturing Apparatus>

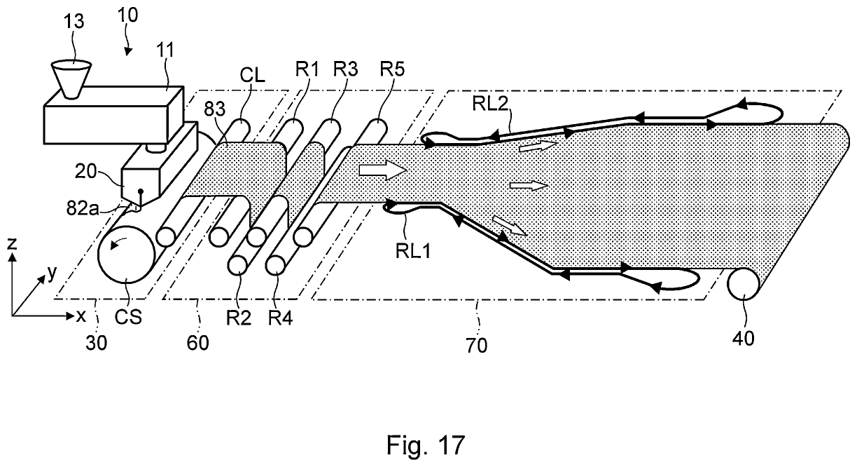

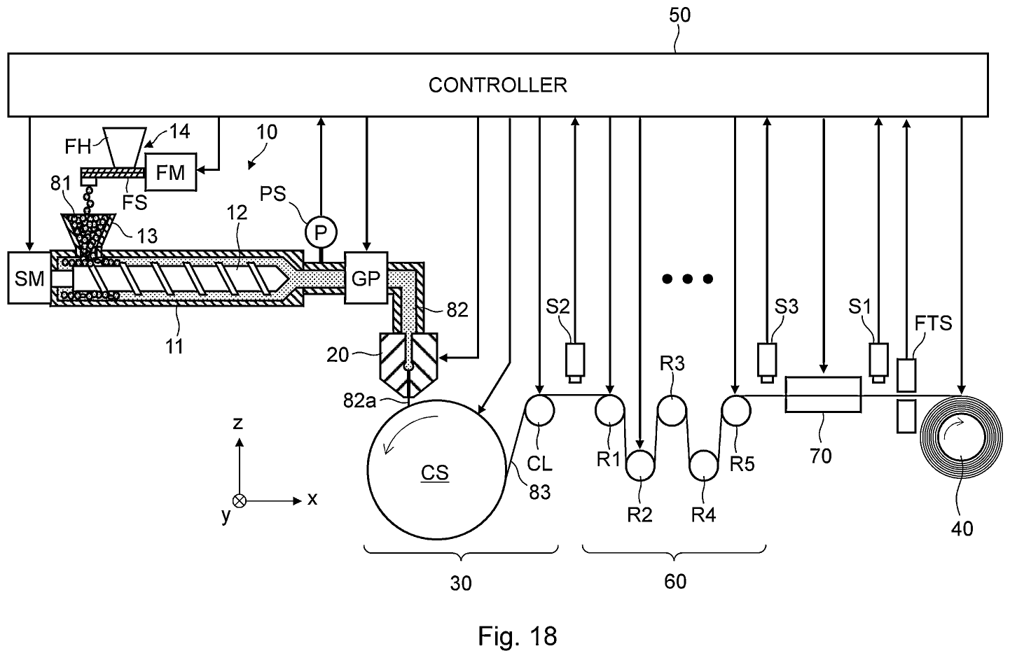

Next, an overall configuration of a resin film manufacturing apparatus according to a second embodiment will be described with reference to FIGS. 17 and 18. FIG. 17 is a schematic perspective view showing an overall configuration of a resin film manufacturing apparatus according to the second embodiment. FIG. 18 is a schematic cross-sectional view showing the overall configuration of the resin film manufacturing apparatus according to the second embodiment.

As shown in FIGS. 17 and 18, the resin film manufacturing apparatus according to this embodiment further includes a longitudinal stretching machine 60 and a transverse stretching machine 70 disposed between the casting machine 30 and the winding machine 40 shown in FIGS. 1 and 2. Specifically, the longitudinal stretching machine 60 is disposed behind (i.e., on the outlet side of) the casting machine 30, and the transverse stretching machine 70 is disposed behind the longitudinal stretching machine 60.

As shown in FIGS. 17 and 18, the longitudinal stretching machine 60 stretches a resin film 83 discharged from the casting machine 30 in the longitudinal direction while conveying the resin film 83. The longitudinal stretching machine 60 shown in FIGS. 17 and 18 includes five rolls R1 to R5. Each of the rolls R1 to R5 is a drive roll driven by a driving source (not shown). The driving sources are, for example, variable-speed motors such as servo motors.

Note that it is sufficient if the longitudinal stretching machine 60 includes a plurality of drive rolls for conveying a resin film 83, and the number and arrangement of the drive rolls provided in the longitudinal stretching machine 60 may be determined as appropriate.

Further, each of the rolls R1 to R5 may include at least one of a cooling mechanism for cooling the resin film 83 and a heating mechanism for heating the resin film 83.

Further, the longitudinal stretching machine 60 may include one or a plurality of nip rolls for pressing the resin film 83 against one of the rolls R1 to R5. The nip roll is not a drive roll.

As shown in FIG. 17, the transverse stretching machine 70 stretches a resin film 83 discharged from the longitudinal stretching machine 60 in its width direction (y-axis direction). More specifically, the transverse stretching machine 70 includes a pair of rails RL1 and RL2. Further, a large number of clips (not shown) are slidably arranged side by side over the whole rails RL1 and RL2.

In FIG. 17, arrows shown for the rails RL1 and RL2 indicate the directions in which the clips move. As shown in FIG. 17, each of the rails RL1 and RL2 has a loop configuration including an outward path along which clips move in the direction in which the resin film 83 is conveyed (i.e., the x-axis positive direction) and a return path along which the clips move in the direction opposite to the direction of the outward path (i.e., the x-axis negative direction). That is, in the transverse stretching machine 70, the clips move along the respective rails RL1 and RL2 each having a loop configuration in a circular route.

As shown in FIG. 17, the rails RL1 and RL2 have a symmetrical configuration with respect to a plane parallel to the xz-plane.

As shown in FIG. 17, in the rails RL1 and RL2, the outward path along which the clips move in the conveyance direction (i.e., the x-axis positive direction) and the return path along which the clips move in the direction opposite to the conveyance direction (i.e., the x-axis negative direction) are arranged roughly in parallel with each other. The return path of the rails RL1 is disposed on an outer side of the resin film 83 in the width direction (i.e., on the negative side in the y-axis direction). The return path of the rails RL2 is also disposed on an outer side the resin film 83 in the width direction (i.e., on the positive side in the y-axis direction).

As shown in FIG. 17, in the outward path of each of the rails RL1 and RL2, a pair of parallel parts parallel to the x-axis are provided at both ends of the rail in the longitudinal direction (x-axis direction), and an oblique part oblique to the y-axis direction is provided between these parallel parts. The oblique part of the rail RL1 is oblique to the y-axis negative direction, and the oblique part of the rail RL2 is oblique to the y-axis positive direction. That is, in the oblique parts of the outward paths of the rails RL1 and RL2, the distance between the rails RL1 and RL2 in the y-axis direction increases as the distance from the x-axis negative ends of the rails in the x-axis positive direction increases.

Note that in the outward paths of the rails RL1 and RL2 shown in FIG. 17, clips move in the x-axis positive direction along the rails RL1 and RL2 while, at the parts at which they are in contact with the resin film 83, holding both ends of the resin film 83 in the width direction (y-axis direction). Therefore, as shown in FIG. 17, in the oblique parts of the outward paths of the rails RL1 and RL2, the resin film 83 is stretched in the width direction (y-axis direction) while being conveyed in the x-axis positive direction.

Note that in the rails RL1 and RL2 shown in FIG. 17, at the parts at which the clips are not in contact with the resin film 83, they move along the rails RL1 and RL2 without holding the resin film 83. More specifically, clips hold the resin film 83 at the inlet of the transverse stretching machine 70, i.e., at the rear ends (the end on the negative side in the x-axis direction) of the rails RL1 and RL2, and then move along the rails RL1 and RL2 in the x-axis positive direction while holding the resin film 83. Then, the clips release the resin film 83 at the outlet of the transverse stretching machine 70, i.e., at the front end (the end on the positive side in the x-axis direction) of the rails RL1 and RL2.

Further, the transverse stretching machine 70 shown in FIG. 1 includes a driving source(s) for driving clips for conveying the resin film 83. The driving source is, for example, a variable-speed motor such as a servo motor.

### <Configuration and Operation of Controller 50>

In this embodiment, when the manufacturing of a resin film 83 is started, the controller 50 starts driving the longitudinal stretching machine 60 at a predetermined timing after detecting, by a film passing sensor S2 shown in FIG. 18, that the resin film 83 has passed therethrough.

Note that the film passing sensor S2 is a film passing sensor for longitudinal stretching that is provided on the inlet side of the longitudinal stretching machine 60 and detects, when the manufacturing is started, the passing of the conveyed resin film 83 therethrough. Meanwhile, it can also be said that instead of the film passing sensor S1 in FIG. 2, the film passing sensor S2 is provided on the outlet side of the casting machine 30 and detects, when the manufacturing is started, that the resin film 83 has passed through the casting machine 30.

Note that a film passing sensor may be provided on each of the outlet side of the casting machine 30 and the inlet side of the longitudinal stretching machine 60.

As described above, the resin film manufacturing apparatus according to this embodiment includes the film passing sensor S2, which is provided on the inlet side of the longitudinal stretching machine 60 and detects the passing of the conveyed resin film 83 therethrough. Further, when the manufacturing of a resin film 83 is started, the driving of the longitudinal stretching machine 60 is started after it is detected, by the film passing sensor S2, that the resin film 83 has passed therethrough. Therefore, in the resin film manufacturing apparatus according to this embodiment, it is possible to, when the manufacturing of the resin film is started, automatically start the stretching of the resin film in the longitudinal direction by the longitudinal stretching machine.

Further, in this embodiment, when the manufacturing of a resin film 83 is started, the controller 50 starts the holding of the resin film 83 by the transverse stretching machine 70 at a predetermined timing after detecting, by a film passing sensor S3 shown in FIG. 18, that the resin film 83 has passed therethrough.

Note that the film passing sensor S3 is a film passing sensor for transverse stretching that is provided on the inlet side of the transverse stretching machine 70 and detects, when the manufacturing is started, the passing of the conveyed resin film 83 therethrough. Meanwhile, it can also be said that the film passing sensor S3 is provided on the outlet side of the longitudinal stretching machine 60 and detects, when the manufacturing is started, that the resin film 83 has passed through the longitudinal stretching machine 60.

Note that a film passing sensor may be provided on each of the outlet side of the longitudinal stretching machine 60 and the inlet side of the transverse stretching machine 70.

As described above, the resin film manufacturing apparatus according to this embodiment includes the film passing sensor S3, which is provided on the inlet side of the transverse stretching machine 70 and detects the passing of the conveyed resin film 83 therethrough. Then, when the manufacturing of a resin film 83 is started, the holding of the resin film 83 by the transverse stretching machine 70 is started after it is detected, by the film passing sensor S3, that the resin film 83 has passed therethrough. Therefore, in the resin film manufacturing apparatus according to this embodiment, it is possible to, when the manufacturing of the resin film is started, automatically start the stretching of the resin film in the crosswise direction by the transverse stretching machine.

Further, in this embodiment, similarly to the first embodiment, when the manufacturing of a resin film 83 is started, the controller 50 starts driving the winding machine 40 at a predetermined timing after detecting, by the film passing sensor S1 shown in FIG. 18, that the resin film 83 has passed therethrough. That is, the winding of the resin film 83 by the winding machine 40 is started.

Note that in this embodiment, the film passing sensor S1 is also a film passing sensor for winding that is provided on the inlet side of the winding machine 40 and detects, when the manufacturing is started, the passing of the conveyed resin film 83 therethrough. Meanwhile, in this embodiment, it can also be said that the film passing sensor S1 is provided on the outlet side of the transverse stretching machine 70 and detects, when the manufacturing is started, that the resin film 83 has passed through the transverse stretching machine 70.

Note that a film passing sensor may be provided on each of the outlet side of the transverse stretching machine 70 and the inlet side of the winding machine 40.

As described above, the resin film manufacturing apparatus according to this embodiment also includes the film passing sensor S1, which is provided on the inlet side of the winding machine 40 and detects the passing of the conveyed resin film 83 therethrough. Further, when the manufacturing of a resin film 83 is started, the driving of the winding machine 40 is started after it is detected, by the film passing sensor S1, that the resin film 83 has passed therethrough. Therefore, in the resin film manufacturing apparatus according to this embodiment, it is possible to, when the manufacturing of the resin film is started, automatically start the winding of the resin film by the winding machine.

As described above, the resin film manufacturing apparatus according to this embodiment includes the film passing sensors S2, S3, and S1, each of which detects the passing of the conveyed resin film 83 therethrough, on the inlet sides of the longitudinal stretching machine 60, the transverse stretching machine 70, and the winding machine 40, respectively. Further, when the manufacturing of a resin film 83 is started, after the film passing sensors S2, S3, and S1 detect the passing of the resin film 83 therethrough, the driving of the longitudinal stretching machine 60, the holding of the resin film 83 by the transverse stretching machine 70, and the driving of the winding machine 40 are successively started.

Therefore, in the resin film manufacturing apparatus according to this embodiment, it is possible to, when the manufacturing of a resin film is started, automatically and successively start the longitudinal stretching, the transverse stretching, and the winding of the resin film performed by the longitudinal stretching machine, the transverse stretching machine, and the winding machine, respectively.

The rest of the configuration is similar to that of the resin film manufacturing apparatus according to the first embodiment shown in FIG. 2, and therefore the description thereof will be omitted.

### <Overall Procedure of Method for Controlling Resin Film Manufacturing Apparatus>

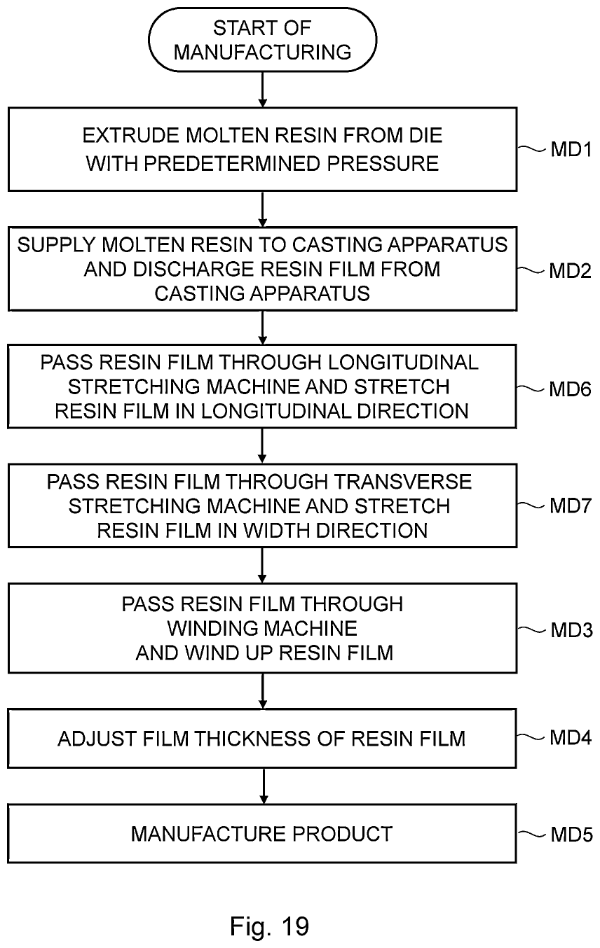

Next, an overall procedure of a method for controlling a resin film manufacturing apparatus according to the second embodiment that is performed when the manufacturing of a resin film is started will be described with reference to FIGS. 18 to 23. FIG. 19 is a flowchart showing an overall procedure of a method for controlling a resin film manufacturing apparatus according to the second embodiment that is performed when the manufacturing of a resin film is started.

As shown in FIG. 19, the method for controlling the resin film manufacturing apparatus according to this embodiment further includes control modes MD6 and MD7 between the control modes MD2 and MD3 shown in FIG. 5.

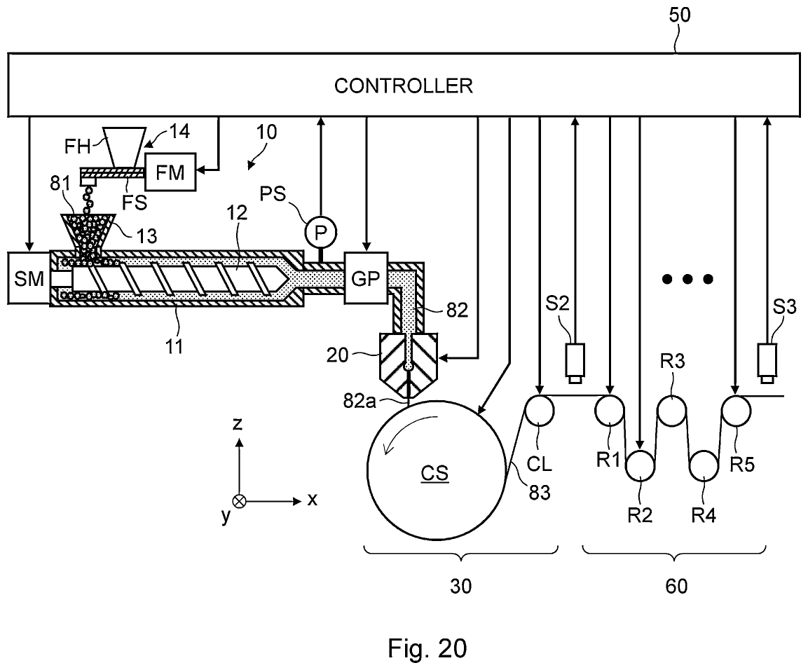

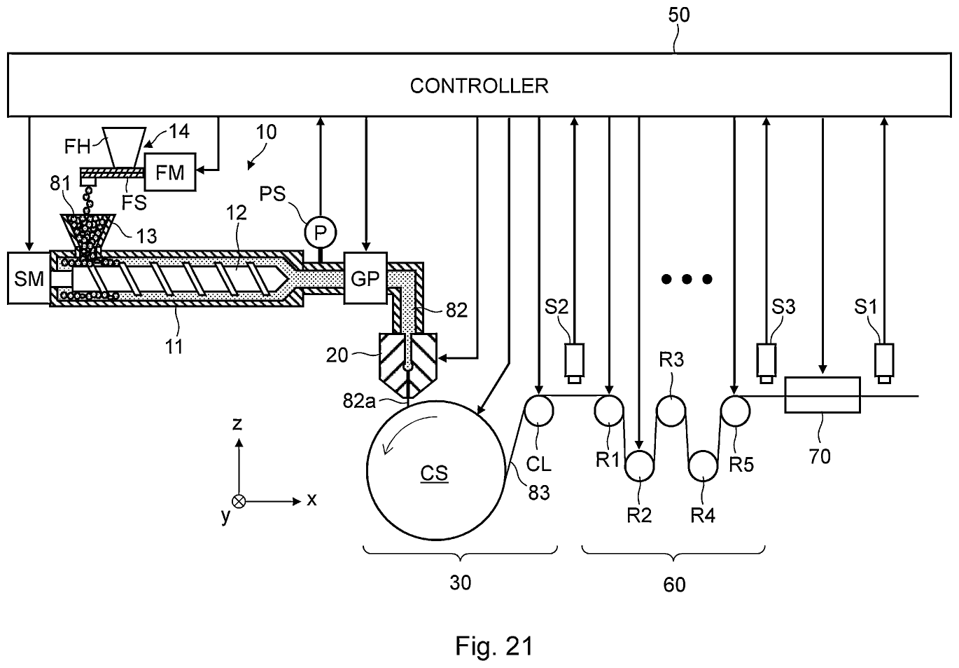

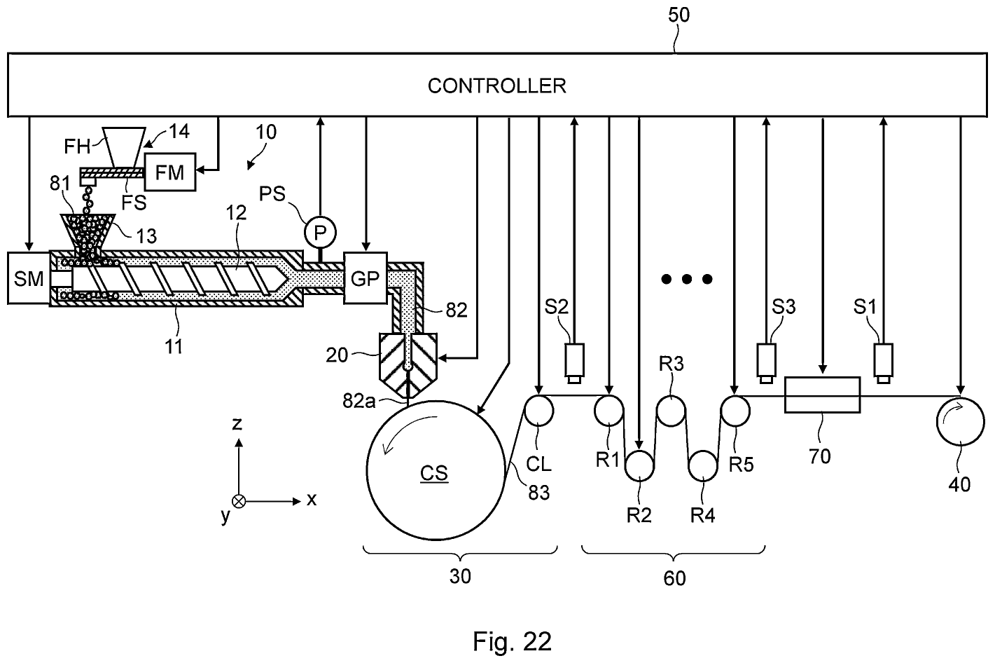

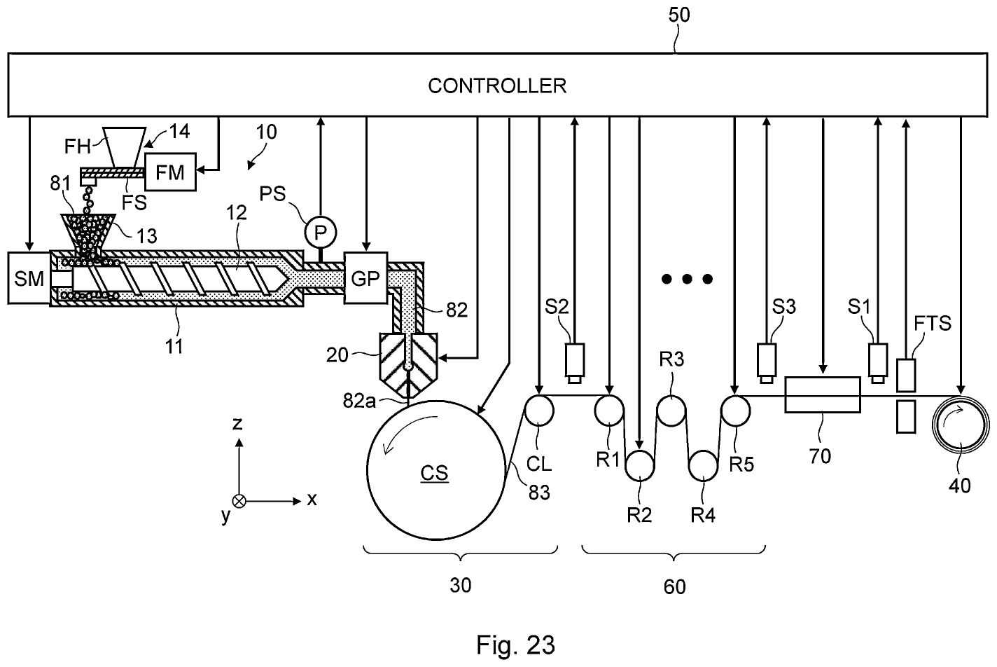

FIGS. 20 and 21 are schematic cross-sectional views showing the resin film manufacturing apparatus in the control modes MD6 and MD7, respectively, in FIG. 19. FIGS. 22 and 23 are schematic cross-sectional views showing the resin film manufacturing apparatus in the control modes MD3 and MD4, respectively, in FIG. 19. FIG. 18 shows the resin film manufacturing apparatus in the control mode MD5 in FIG. 19.

Note that the control of the resin film manufacturing apparatus shown in FIG. 19 is performed by the controller 50, which is a computer. Details of each of the control modes MD6 and MD7 added in this embodiment will be described later.

Further, the control modes MD1 and MD2 shown in FIG. 19 are the same as the control modes MD1 and MD2 shown in FIG. 5, and therefore detailed descriptions thereof will be omitted.

As shown in FIGS. 19 and 20, after the control mode MD2, the driving of the longitudinal stretching machine 60 is started, and the resin film 83 is passed through the longitudinal stretching machine 60 and stretched in the longitudinal direction (Control Mode MD6). Specifically, the controller 50 starts driving the longitudinal stretching machine 60 at a predetermined timing after detecting the resin film 83 discharged from the casting machine 30 by using the film passing sensor S2 shown in FIG. 20.

Next, as shown in FIGS. 19 and 21, the resin film 83 is passed through the transverse stretching machine 70 and stretched in the width direction (Control Mode MD7). Specifically, the controller 50 starts the holding of the resin film 83 by the transverse stretching machine 70 at a predetermined timing after detecting the resin film 83 discharged from the longitudinal stretching machine 60 by using the film passing sensor S3 shown in FIG. 21.

Next, as shown in FIGS. 19 and 22, the driving of the winding machine 40 is started, and the resin film 83 is passed through and wound up around the winding machine 40 (Control Mode MD3). Specifically, the controller 50 starts driving the winding machine 40 at a predetermined timing after detecting the resin film 83 discharged from the transverse stretching machine 70 by using the film passing sensor S1 shown in FIG. 22.

Next, as shown in FIGS. 19 and 23, the film thickness of the resin film 83 is adjusted (Control Mode MD4). Specifically, the controller 50 performs feedback control for the lip distance of the T-die 20 based on the thickness distribution of the resin film 83 acquired from the film thickness sensor FTS shown in FIG. 23. In this embodiment, the film thickness sensor FTS measures the thickness distribution of the resin film 83, which was discharged from the transverse stretching machine 70 and is being conveyed, in the width direction thereof.

Note that a film thickness sensor may be further provided at at least one of the outlets of the casting machine 30 and the longitudinal stretching machine 60.

Further, as shown in FIGS. 18 and 19, after the control mode MD4 for adjusting the film thickness of the resin film 83 is finished, the controller 50 switches the control mode to the control mode MD5 for manufacturing a product. That is, the manufacturing of a resin film 83 as a product is started.

### <Details of Control Mode MD6>

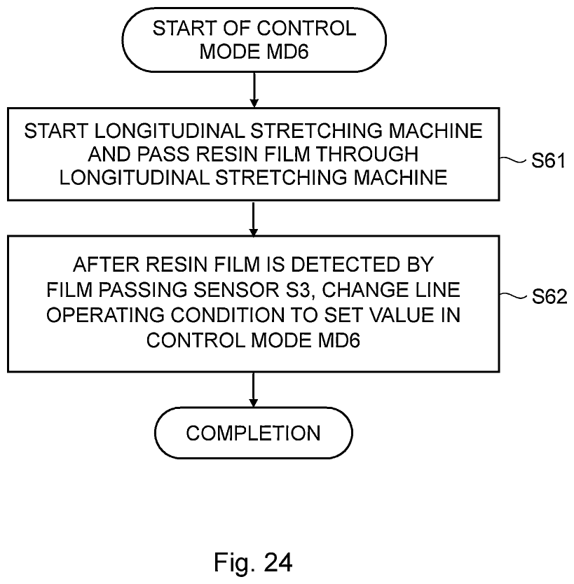

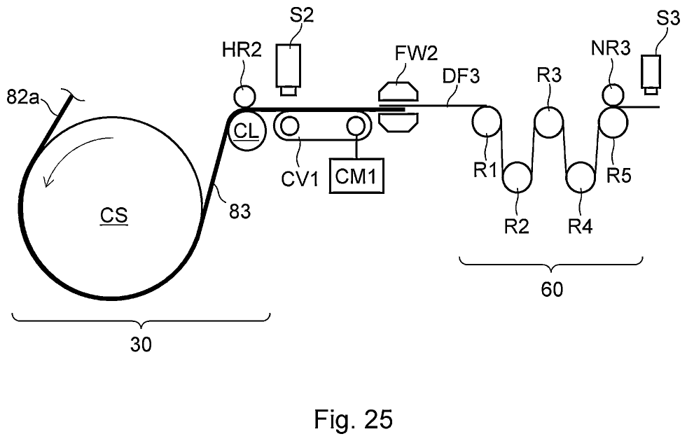

Next, details of the control mode MD6 in FIG. 19 will be described with reference to FIGS. 24 and 25. FIG. 24 is a flowchart showing details of the control mode MD6 in FIG. 19. FIG. 25 is a schematic cross-sectional view showing the casting machine 30 and the longitudinal stretching machine 60 in a step S61 in FIG. 24.

Note that the control shown in FIG. 24 is also performed by the controller 50, which is a computer.

Firstly, as shown in FIG. 24, the longitudinal stretching machine 60 is started, and a resin film 83 is passed through the longitudinal stretching machine 60 (Step S61). Specifically, after a resin film 83 discharged from the casting machine 30 is detected by the film passing sensor S2, the longitudinal stretching machine 60 is started at a predetermined timing.

An example of the step S61 will be described hereinafter with reference to FIG. 25. In the example shown in FIG. 25, a film connecting apparatus FW2 for longitudinal stretching that connects films to each other is provided between the film passing sensor S2 and the longitudinal stretching machine 60. For example, similarly to the film connecting apparatus FW1, the film connecting apparatus FW2 welds resin films to each other.

Before starting the longitudinal stretching machine 60 in the step S61, the leading end of a dummy film DF3 for longitudinal stretching is sandwiched between the roll R5 and the nip roll NR3 disposed at the rear end of the longitudinal stretching machine 60 in advance. Meanwhile, the trailing end of the dummy film DF3 is disposed in the film connecting apparatus FW2 in advance. These operations are, for example, manually performed, but may be performed by a robot or the like.

Then, after a resin film 83 is detected by the film passing sensor S2, the resin film 83 and the dummy film DF3 are connected to each other by the film connecting apparatus FW2 at a predetermined timing, and then the longitudinal stretching machine 60 is started. Through this series of operations, it is possible to automatically pass the resin film 83 through the longitudinal stretching machine 60, and thereby to automatically start the longitudinal stretching of the resin film 83.

Note that in the example shown in FIG. 25, the resin film 83 discharged from the casting machine 30 is conveyed to the film connecting apparatus FW2 by a conveyor CV1. The conveyor CV1 is driven by a conveyor motor CM1. The conveyor motor CM1 is controlled by the controller 50.

Note that the conveyor CVI shown in FIG. 25 is not indispensable. Meanwhile, in FIG. 14, the resin film 83 discharged from the casting machine 30 may be conveyed to the film connecting apparatus FW1 by a conveyor (not shown).

Next, as shown in FIG. 24, when the resin film 83 discharged from the longitudinal stretching machine 60 is detected by the film passing sensor S3 shown in FIG. 25, the line operating condition is changed to a set value for the control mode MD6 (Step S62). For example, the line speed is increased to a set value for the control mode MD6. Thorough the above-described series of processes, the control mode MD6 is completed.

### <Details of Control Mode MD7>

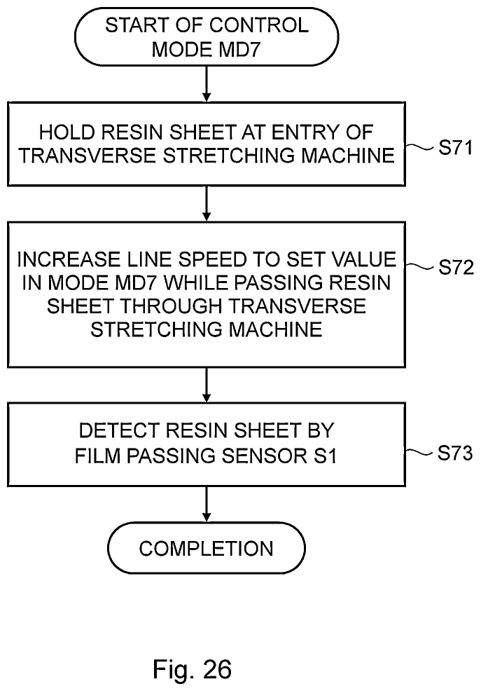

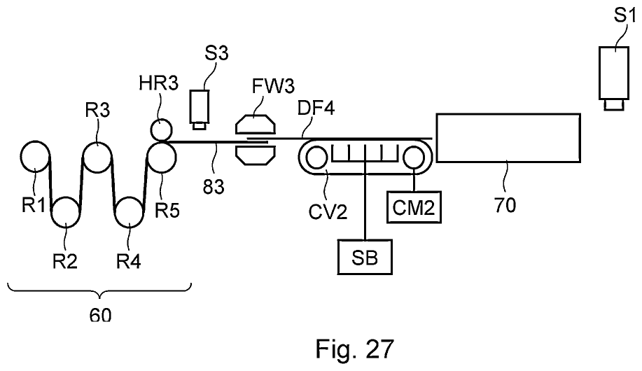

Next, details of the control mode MD7 in FIG. 19 will be described with reference to FIGS. 26 and 27. FIG. 26 is a flowchart showing details of the control mode MD7 in FIG. 19. FIG. 27 is a schematic cross-sectional view showing the longitudinal stretching machine 60 and the transverse stretching machine 70 in a step S71 in FIG. 26.

Note that the control shown in FIG. 26 is also performed by the controller 50, which is a computer.

Firstly, as shown in FIG. 26, a resin film 83 is held at the inlet of the transverse stretching machine 70 (Step S71). Specifically, after a resin film 83 discharged from the longitudinal stretching machine 60 is detected by the film passing sensor S3, the holding of the resin film 83 by the transverse stretching machine 70 is started at a predetermined timing.

Note that the transverse stretching machine 70 has already been started before the step S71, and the clips are moving along the rails RL1 and RL2 in a circular route.

An example of the step S71 will be described hereinafter with reference to FIG. 27. In the example shown in FIG. 27, a film connecting apparatus FW3 for transverse stretching that connects films to each other is provided between the film passing sensor S3 and the transverse stretching machine 70. For example, similarly to the film connecting apparatus FW1, the film connecting apparatus FW3 welds resin films to each other.

In the example shown in FIG. 27, before the step S71, the leading end of a dummy film DF4 for transverse stretching is disposed at the inlet of the transverse stretching machine 70. Meanwhile, the trailing end of the dummy film DF4 is disposed in the film connecting apparatus FW3. These operations are, for example, manually performed, but may be performed by a robot or the like.

Note that in the example shown in FIG. 27, the dummy film DF4 is disposed over a conveyor CV2 extending from the film connecting apparatus FW3 to the inlet of the transverse stretching machine 70. The conveyor CV2 can convey the dummy film DF4 while sucking it by a suction blower SB. The conveyor CV2 is driven by a conveyor motor CM2. The conveyor motor CM2 and the suction blower SB are controlled by the controller 50.

Then, after a resin film 83 is detected by the film passing sensor S3, the resin film 83 and the dummy film DF4 are connected to each other by the film connecting apparatus FW3 at a predetermined timing, and then the conveyor CV2 is stated and the holding of the resin film 83 by the transverse stretching machine 70 is started. Through this series of operations, it is possible to automatically pass the resin film 83 through the transverse stretching machine 70, and thereby to automatically start the transverse stretching of the resin film 83.

More specifically, through the above-described series of operations, while the dummy film DF4 connected to the resin film 83 is being conveyed by the conveyor CV2, the leading end of the dummy film DF4 is held by clips at the inlet of the transverse stretching machine 70. After that, when it is determined that the resin film 83 is held by the clips, for example, based on the lapse of a predetermined time, the conveyor motor CM2 and the suction blower SB are stopped.

Note that in FIG. 27, the resin film 83 discharged from the casting machine 30 may be conveyed to the film connecting apparatus FW3 by a conveyor (not shown). Further, a sensor for checking the holding of the resin film 83 by clips may be separately provided at the inlet of the transverse stretching machine 70.

Next, as shown in FIG. 26, while the resin film 83 is passed through the transverse stretching machine 70, the line speed is increased to a set value for the control mode MD7 (Step S72).

Then, as shown in FIG. 26, after the resin film 83 discharged from the transverse stretching machine 70 is detected by the film passing sensor S1 shown in FIG. 27 (Step S73), the control mode MD7 is completed.

### <Details of Control Mode MD3>

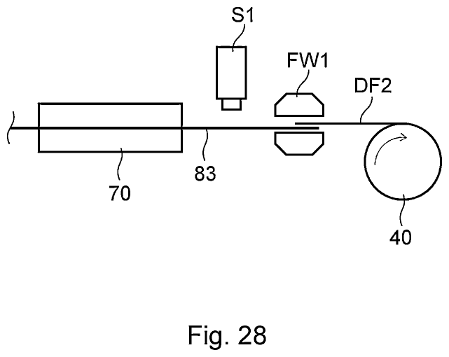

Next, details of the control mode MD3 shown in FIG. 19 will be described with reference to FIGS. 13 and 28. FIG. 13, which is used for the description of the first embodiment, is also used for the following description. FIG. 28 is a schematic cross-sectional view showing the transverse stretching machine 70 and the winding machine 40 in a step S31 in FIG. 13 in the second embodiment.

Firstly, as shown in FIG. 13, the winding machine 40 is started, and the winding of a resin film 83 is started under constant rotation control (Step S31). Specifically, after the step S73 in FIG. 26, in which the resin film 83 is detected by the film passing sensor S1, the winding machine 40 is started at a predetermined timing.

An example of the step S31 in this embodiment will be described hereinafter with reference to FIG. 28. In the example shown in FIG. 28, a film connecting apparatus FW1 for winding that connects films to each other is provided between the film passing sensor S1 and the winding machine 40.

Before starting the winding machine 40 in the step S31, the leading end of a dummy film DF2 is fixed to the winding machine 40 in advance. Meanwhile, the trailing end of the dummy film DF2 is disposed in the film connecting apparatus FW1. These operations are, for example, manually performed, but may be performed by a robot or the like.

Then, after a resin film 83 discharged from the transverse stretching machine 70 is detected by the film passing sensor S1, the resin film 83 and the dummy film DF2 are connected to each other by the film connecting apparatus FW1 at a predetermined timing, and then, the winding machine 40 is started. Through this series of operations, it is possible to automatically pass the resin film 83 through the winding machine 40, and thereby to automatically start the winding of the resin film 83.

The subsequent steps S32 and S33 shown in FIG. 13 in this embodiment are also similar to those in the first embodiment, and therefore descriptions thereof will be omitted.

Details of the control modes MD4 and MD5 are similar to those in the first embodiment shown in FIGS. 15 and 16, and therefore detailed descriptions thereof will be omitted.

The rest of the configuration is similar to that in the first embodiment, and therefore the description thereof will be omitted.

Note that in this embodiment, only one of the longitudinal stretching machine 60 and the transverse stretching machine 70 may be provided. Alternatively, a plurality of longitudinal stretching machines 60 and/or a plurality of transverse stretching machines 70 may be provided.

In the above-described examples, the program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (Registered Trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A resin film manufacturing apparatus comprising:
an extruder configured to melt a resin material charged therein and then extrude the molten resin material;
a die connected to the extruder and configured to shape the molten resin into a film-like shape;
a casting machine including a cast roll configured to, while cooling the film-like molten resin extruded from the die, convey a resin film, the resin film being formed as the molten resin solidifies;
a winding machine configured to wind up the manufactured resin film;
a film passing sensor for winding, provided on an inlet side of the winding machine and configured to detect passing of the conveyed resin film therethrough; and
a controller configured to control manufacturing of the resin film, wherein
when the manufacturing of the resin film is started, the controller starts driving the winding machine after detecting, by the film passing sensor for winding, that the resin film has passed therethrough.

2. The resin film manufacturing apparatus according to claim 1, further comprising a film connecting apparatus for winding, provided between the film passing sensor for winding and the winding machine, and configured to connect films to each other, wherein
when the manufacturing of the resin film is started, the controller starts driving the winding machine after making the film connecting apparatus for winding connect the resin film detected by the film passing sensor for winding with a dummy film for winding already-fixed to the winding machine.

3. The resin film manufacturing apparatus according to claim 2, wherein the film connecting apparatus for winding welds the dummy film for winding to the resin film.

4. The resin film manufacturing apparatus according to claim 1, wherein the controller:
sets, when the driving of the winding machine is started, the control of the winding machine to constant rotation control; and
switches, after a tension is detected in the winding machine, the control of the winding machine to constant tension control.

5. The resin film manufacturing apparatus according to claim 1, further comprising:
a longitudinal stretching machine provided behind the casting machine and configured to stretch the resin film in a longitudinal direction; and
a film passing sensor for longitudinal stretching, provided on an inlet side of the longitudinal stretching machine and configured to detect passing of the conveyed resin film therethrough, wherein
when the manufacturing of the resin film is started, the controller starts driving the longitudinal stretching machine after detecting, by the film passing sensor for longitudinal stretching, that the resin film has passed therethrough.

6. The resin film manufacturing apparatus according to claim 5, further comprising a film connecting apparatus for longitudinal stretching, provided between the film passing sensor for longitudinal stretching and the longitudinal stretching machine, and configured to connect films to each other, wherein
when the manufacturing of the resin film is started, the controller starts driving the longitudinal stretching machine after making the film connecting apparatus for longitudinal stretching connect the resin film detected by the film passing sensor for longitudinal stretching with a dummy film for longitudinal stretching, already-fixed to the longitudinal stretching machine.

7. The resin film manufacturing apparatus according to claim 6, wherein the film connecting apparatus for longitudinal stretching welds the dummy film for longitudinal stretching to the resin film.

8. The resin film manufacturing apparatus according claim 5, further comprising:
a transverse stretching machine provided behind the longitudinal stretching machine and configured to stretch the resin film in a width direction; and
a film passing sensor for transverse stretching, provided on an inlet side of the transverse stretching machine and configured to detect passing of the conveyed resin film therethrough, wherein
when the manufacturing of the resin film is started, the controller starts holding of the resin film by the transverse stretching machine after detecting, by using the film passing sensor for transverse stretching, that the resin film has passed therethrough.

9. The resin film manufacturing apparatus according to claim 8, further comprising a film connecting apparatus for transverse stretching, provided between the film passing sensor for transverse stretching and the transverse stretching machine, and configured to connect films to each other, wherein
when the manufacturing of the resin film is started, the controller starts holding of the resin film by the transverse stretching machine after making the film connecting apparatus for transverse stretching connect the resin film detected by the film passing sensor for transverse stretching with a dummy film for transverse stretching, disposed so as to extend to an inlet of the transverse stretching machine.

10. The resin film manufacturing apparatus according to claim 9, wherein the film connecting apparatus for transverse stretching welds the dummy film for transverse stretching to the resin film.

11. A method for controlling a resin film manufacturing apparatus, the resin film manufacturing apparatus comprising:
an extruder configured to melt a resin material charged therein and then extrude the molten resin material;
a die connected to the extruder and configured to shape the molten resin into a film-like shape;
a casting machine including a cast roll configured to, while cooling the film-like molten resin extruded from the die, convey a resin film, the resin film being formed as the molten resin solidifies;
a winding machine configured to wind up the manufactured resin film, wherein
when manufacturing of the resin film is started, a computer performs
(a) starting driving of the winding machine after detecting, by using a film passing sensor for winding, provided on an inlet side of the winding machine, that the resin film has passed therethrough.

12. The method for controlling a resin film manufacturing apparatus according to claim 11, wherein
the resin film manufacturing apparatus further comprises a film connecting apparatus for winding, provided between the film passing sensor for winding and the winding machine, and configured to connect films to each other, and
in (a), driving of the winding machine is started after the resin film detected by the film passing sensor for winding is connected with a dummy film for winding already-fixed to the winding machine by the film connecting apparatus for winding.

13. The method for controlling a resin film manufacturing apparatus according to claim 12, wherein in (a), the film connecting apparatus for winding welds the dummy film for winding to the resin film.

14. The method for controlling a resin film manufacturing apparatus according to claim 11, wherein in (a),
when the driving of the winding machine is started, the control of the winding machine is set to constant rotation control; and
after a tension is detected in the winding machine, the control of the winding machine is switched to constant tension control.

15. The method for controlling a resin film manufacturing apparatus according to claim 11, wherein
the resin film manufacturing apparatus further comprises a longitudinal stretching machine provided behind the casting machine and configured to stretch the resin film in a longitudinal direction, and
when the manufacturing of the resin film is started, the computer performs, before (a),
(b) starting driving of the longitudinal stretching machine after detecting, by using a film passing sensor for longitudinal stretching, provided on an inlet side of the longitudinal stretching machine, that the resin film has passed therethrough.

16. The method for controlling a resin film manufacturing apparatus according to claim 15, wherein
the resin film manufacturing apparatus further comprises a film connecting apparatus for longitudinal stretching, provided between the film passing sensor for longitudinal stretching and the longitudinal stretching machine, and configured to connect films to each other, and
in (b), driving of the longitudinal stretching machine is started after the resin film detected by the film passing sensor for longitudinal stretching is connected with a dummy film for longitudinal stretching, already-fixed to the longitudinal stretching machine by the film connecting apparatus for longitudinal stretching.

17. The method for controlling a resin film manufacturing apparatus according to claim 16, wherein in (b), the film connecting apparatus for longitudinal stretching welds the dummy film for longitudinal stretching to the resin film.

18. The method for controlling a resin film manufacturing apparatus according to claim 15, wherein
the resin film manufacturing apparatus further comprises a transverse stretching machine provided behind the longitudinal stretching machine and configured to stretch the resin film in a width direction, and
when the manufacturing of the resin film is started, the computer performs, after (b) and before (a),
(c) starting holding of the resin film by the transverse stretching machine after detecting, by using a film passing sensor for transverse stretching, provided on an inlet side of the transverse stretching machine, that the resin film has passed therethrough.

19. The method for controlling a resin film manufacturing apparatus according to claim 18, wherein
the resin film manufacturing apparatus further comprises a film connecting apparatus for transverse stretching, provided between the film passing sensor for transverse stretching and the transverse stretching machine, and configured to connect films to each other, and
in (c), holding of the resin film is started by the transverse stretching machine after the resin film detected by the film passing sensor for transverse stretching is connected with a dummy film for transverse stretching, disposed so as to extend to an inlet of the transverse stretching machine.

20. The method for controlling a resin film manufacturing apparatus according to claim 19, wherein in (c), the film connecting apparatus for transverse stretching welds the dummy film for transverse stretching to the resin film.
